(19) United States
(12) Patent Application Publication
(10) Pub. No.: US 2007/0100838 A1
(43) Pub. Date: May 3, 2007

(54) Outfit exchange service platform

(76) Inventor: Marina Sartor, Surbiton (GB)

Correspondence Address: MARINA SARTOR, 1 HERBERT COURT, FULMAR CLOSE, SURBITON, KTS 8QH, GB

(21) Appl. No.: 11/265,233

(22) Filed: Nov. 3, 2005

(51) Int. Cl. G06F 17/30

(52) U.S. Cl. 707/10

(57) ABSTRACT

An internet-based service platform that enables users to record the details of the time and place where a specific event is going to take place. Users can then add the details of the outfit that they are planning to wear to that specific event. If an event is already recorded in the database the user can simply add the details of the outfit that they are going to wear to that event. The information logged on the database is saved in the format of a searchable database, so that users can also see what outfit other users are going to wear to a specific event or where and when a specific outfit is going to be worn.

### BACKGROUND OF THE INVENTION

1. Field of Invention

Process claim

2. Description of Prior Art

To the applicant's knowledge there is currently no system available that enables the exchange of information between people not acquainted with each other on outfits that people are going to wear to a specific event.

Further, there is no system that enables people who do not know each other and own a same outfit to track the events where the outfit will be worn.

At present individuals who want to know what other people are going to wear to a specific event can communicate verbally with other people attending a specific event.

For high profile events designers sometimes note that a specific outfit is going to be worn to certain event. In this way, guests of that event know that no-one else will be wearing the same dress to that event.

### BRIEF SUMMARY OF THE INVENTION

The invention is an internet-based service platform that enables users to record the details of the time and place where a specific event is going to take place. Users can then add the details of the outfit that they are planning to wear to that specific event. If an event is already recorded in the database the user can simply add the details of the outfit that they are going to wear to that event.

The information logged on the database is saved in the format of a searchable database, so that users can also see what outfit other users are going to wear to a specific event. Alternatively users can search for a specific outfit and find out where and when that outfit will be worn.

The system includes a level of privacy by giving the user that adds an event the option to mark the event as ‘private’, so that the details of the event date and place as well as the outfits that are going to be worn can only be viewed by users who have a password to access that specific event. To mark an event as ‘private’ the user adding the event has to enter an “event password” of his/her choice. For events marked as private, it is up to the discretion of the person adding the event to forward the event password to other guests of the event.

### OBJECTIVE OF THE INVENTION

The objectives are to provide individuals with a means of sharing what they are going to wear to a specific event and track where or when specific outfits are going to be worn. This can help users make an informed decision as to what would be appropriate to wear to specific events.

### ADVANTAGES OF THE INVENTION

The applicant believes that the Outfit Exchange Service Platform will help users decide what to wear to specific events.

Users will access the service platform to find out what other people are going to wear or to track where/when a specific outfit is going to be worn. This can help the user choose an outfit for him/herself that is in accordance with what other people are going to wear, or that stands out, if that is what the user wishes. Other users may just wish to be sure that no-one else is going to wear the same dress/outfit to a certain event.

At present, individuals can discuss with acquaintances their choices. For high profile events it is known that some designers can note if a specific person is going to wear a specific outfit to a certain event. Thus, that designer can advise another customer what to wear accordingly, so that the two guests do not end up accidentally wearing the same outfit to an event.

However, there is currently no tool that enables people to share what they are going to wear with other guests that they may not know. The Outfit Exchange Service Platform provides a system that enables the sharing of this information globally, via a simple internet system.

### BRIEF DESCRIPTION OF THE SEVERAL VIEWS OF THE DRAWING

FIG. 1 is a sample registration form as it appears on the screen of a remote computer.

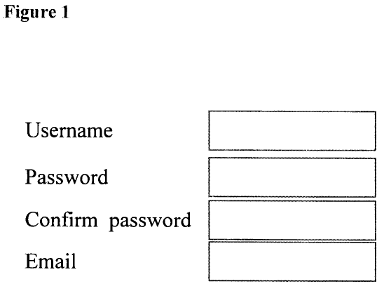

FIG. 2 is a sample form to add a new event as it appears on the screen of a remote computer.

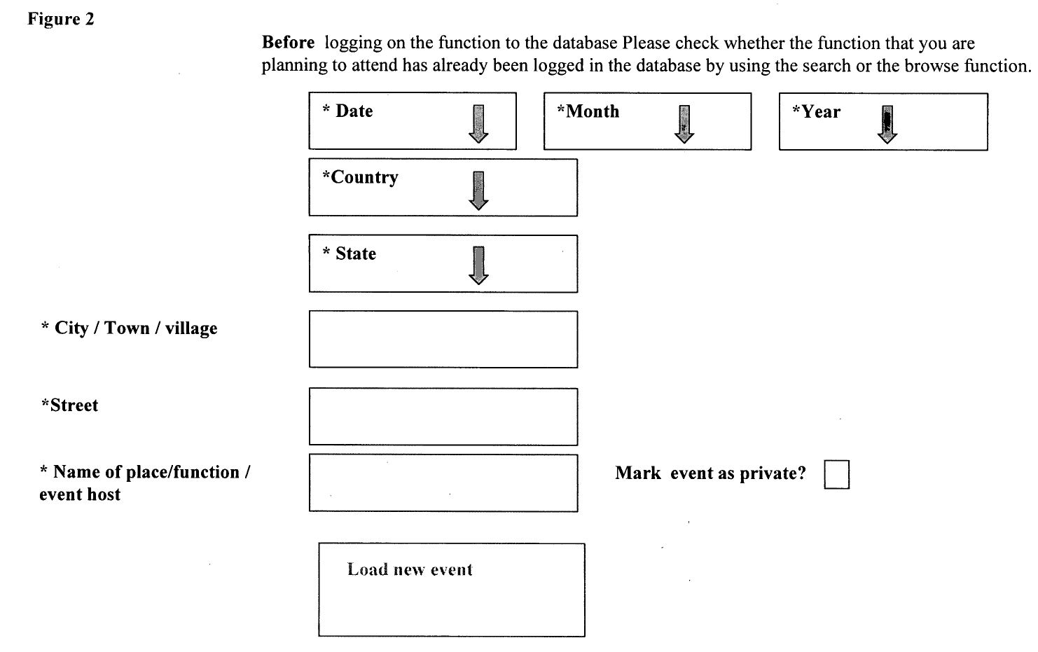

FIG. 3 is a sample form to add a new outfit to a specific event as it appears on the screen of a remote computer.

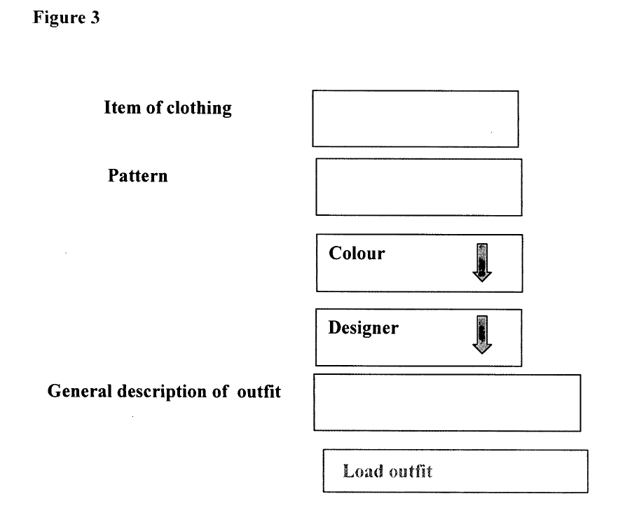

FIG. 4 is an example search result of events.

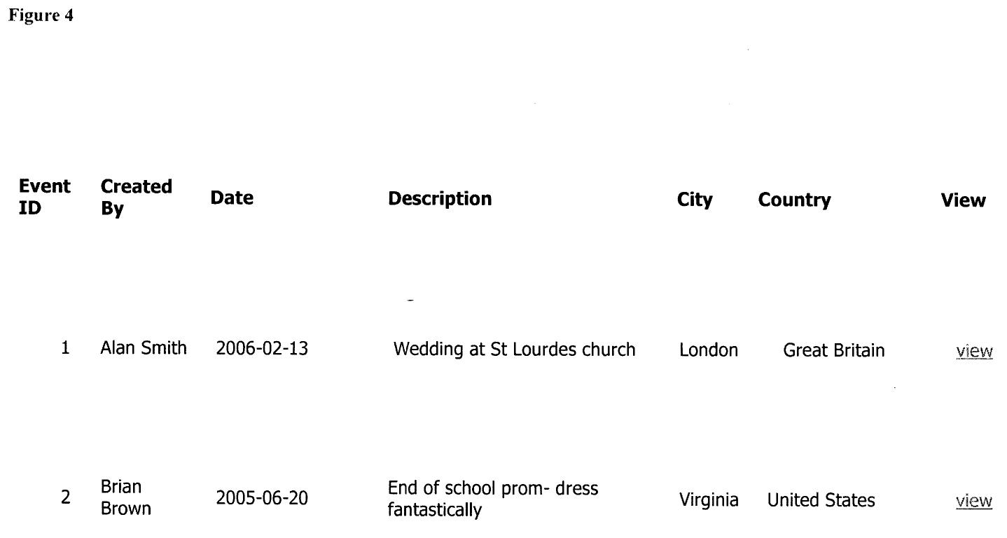

FIG. 5 is an example of the details of an event as it appears on the screen of a remote computer.

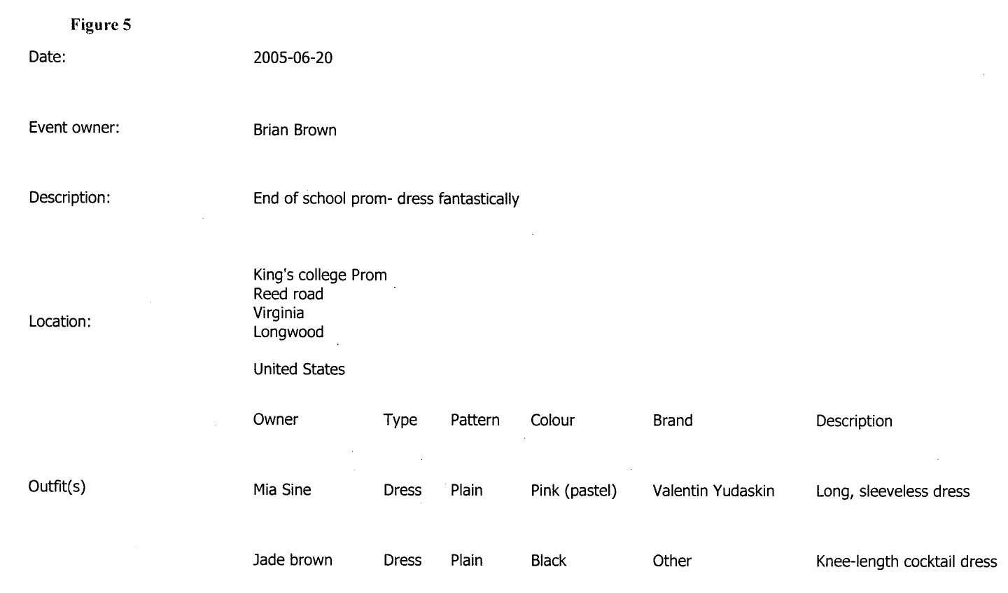

### DETAILED DESCRIPTION OF THE INVENTION

A system whereby users are provided with a universal resource locator (URL), that enables the recording of details of the time and place where any event will be taking place as well as the details of the outfit that they are planning to wear to a chosen, specific event. The information logged on the URL is saved in the format of a searchable database, so that a user is able to see what outfits other users are going to wear to a specific event, or track where and when a specific outfit is going to be worn.

Users register in order to enter the database and add information to it, search it or edit information that they may have entered previously. Each user enters a username, a password and contact details when they register.

Users add a new event by clicking on a link indicating this function. The user then enters the details of the time and place where the event is going to take place, and gives the event a name and enters the name of the host of the event if there is one. The system automatically checks for similar entries so that in cases where the event has been previously entered the user is given the option of not continuing with the new addition. Once the new event has been logged, the user receives a message on the screen indicating that the event has been logged to the database and that the user is able to view and modify any data that he/she has entered by clicking on the link “view my profile”. Users are not able to modify data entered by other users.

Once a new event has been added the user is given a unique URL and event number to be able to access easily this event in the future.

When a user enters a new event, the user is given the option of marking an event as “private”. To mark an event as private the user enters another password of his/her choice. This is the event password. Other users need the event password to add an outfit to this event. Users searching/browsing the database are not able to see when or where “private events” are taking place, or what outfits have been added to these events unless they are able to enter the event password. If an event is not marked as private anybody in the database can view the outfits added to that event as well as being able to add an outfit to that event.

To view the outfits that people are planning to wear to a specific event the user identifies the event by searching or browsing the database, and then accesses the event by clicking on the hyperlink for the event. The details of all outfits logged for that specific event are then displayed.

A user adds an outfit to an event by identifying the specific event that he/she is planning to attend by searching or browsing the database, or by adding the details of the event him/herself if this event is not already in the database and then clicking on the link that indicates the function to add an outfit. The user is asked to enter details of the outfit that he/she is going to wear to the event The user enters the information. Once the outfit has been logged, the user receives a message on the screen indicating that the outfit has been logged to the database and that the user is able to view and modify any data that he/she has entered by clicking on the link “view my profile”. Users are not able to modify data entered by other users.

To search for an event or an outfit the user clicks on the link indicating this function. The user can also browse through the events by clicking on the link indicating this function.

What is claimed is:

1. A method for sharing information on what people are going to wear to a specific event and where and when a specific outfit is going to be worn comprising the following:
providing a means for submission of data describing the place and date when an event is going to take place;
providing a means for submission of data describing what one is going to wear to a specific event listed in the event database;
storing said data in a computer retrievable format accessible via the global computer network;
providing a mechanism that enables users to view the stored data.

2. A method as claimed in claim 1, wherein participation of the users in the sharing of information is effected by the steps of:
a user logging the date and place where an event is going to take place;
said information being displayed to remote users;
users adding the details of the outfit that they are going to wear to an event and said information also being displayed to remote users so that new users can view what outfits previous users have added to a specific event.

3. The method of claim 1 wherein the critical pertinent data for the event include date and address and the option of giving the event a name.

4. The method of claim 1 wherein the critical pertinent data for the outfit that include the garment type, style, colour, pattern, designer and option to enter a free text description.

5. The method of claim 1 wherein the means for submission is a questionnaire adapted to be completed via the global computer network.
